(19) United States
(12) Patent Application Publication
(10) Pub. No.: US 2011/0146887 A1
(43) Pub. Date: Jun. 23, 2011

(54) TIRE PLY AND METHOD OF MANUFACTURE

(76) Inventor: Daniel Ray Downing, Uniontown, OH (US)

(21) Appl. No.: 12/643,305

(22) Filed: Dec. 21, 2009

(51) Int. Cl. B29D 30/30

(52) U.S. Cl. 156/123

(57) ABSTRACT

A method of forming a layer of tire ply is disclosed. A first sheet of ply is provided st lateral end, and having a plurality of functional reinforcement cords and two or more dummy spacer cords at the first lateral end. A second sheet of ply is provided having a second lateral end to be joined together with the first lateral end of the first sheet of ply. The second sheet of ply has a plurality of functional reinforcement cords and two or more dummy spacer cords at the second lateral end. The first and second lateral ends are overlapped so that the dummy cord of one of the ends is located adjacent a functional cord of the second of the ends.

### FIELD OF THE INVENTION

The invention relates to tire ply and method of manufacturing tires.

### BACKGROUND OF THE INVENTION

Tires are typically comprised of one or more layers of ply. The one or more plies are typically applied in a sheet form onto a tire building drum. The sheet of ply is wrapped about the drum, cut to the desired length and then assembled together. Prior to being brought to the drum, the ply composite must go through a lengthy component preparation process. The first step in the process is to form ply fabric at a fabric facility. At this facility, a fabric comprised of longitudinal ply cords 5 are made into a long continuous sheet 1, as shown in FIG. 1. A pic cord 7 is woven across the cords and into the fabric and functions to maintain the spacing of the longitudinal cords. The pic cord is typically made of a low strength or lightweight material. After this weaving process, the fabric is dipped into an adhesive for future processing into rubber. In the tire plant, this fabric is then run through a fabric calendar where rubber ply coat compound is adhered to both sides of the fabric. This rubber penetrates between the ply cords. This roll of calendered stock is then taken to a ply shear wherein the calendered stock is cut into sheets of a defined length 10. The cut ends 12 of each sheet are spliced together in a “sidewise” manner, as shown in FIG. 2. This invention relates to these “component preparation” splices which occur at the ply shear. The ends 12 of the ply are typically overlapped as a lap joint, as shown in FIG. 3. This stock is then rolled up and taken to the tire building drum. Once built into a finished tire, the ply in regions B causes a restriction in the ply due to the added strength and stiffness of the overlapped ply cords. Regions A and C typically have excessive spreading between the cords due to their proximity to the restriction in region B. The overlap of ply material can contribute to tire high speed nonuniformity. It is known in the art to join the ply ends via a butt splice, wherein there is no overlap of material. However, forming a butt splice joint generally requires additional capital equipment in order to form the butt splice. The butt splice is also not as strong or as reliable as the lap slice.

Thus an improved method and apparatus for forming a splice that does not require an additional investment in capital equipment is described.

### SUMMARY OF THE INVENTION

The invention provides in a first aspect a method of forming a layer of tire ply comprising the following steps: providing a sheet of ply having a first and second lateral ends to be joined together; wherein said sheet of ply formed of a plurality of functional reinforcement cords and having two or more “dummy” spacer cords at each later end; overlapping the first and second lateral end so that the dummy cord of one of said ends is located adjacent a functional cord of the second of said ends.

The invention provides in a second aspect a method of forming a layer of tire ply comprising the following steps: providing a sheet of ply having a first and second lateral ends to be joined together; said sheet of ply formed of a plurality of functional reinforcement cords and having two or more dummy spacer cords at one of said ends; overlapping the first and second lateral end so that the dummy cords of one of said ends is located adjacent the functional cords of the second of said ends.

A third aspect of the invention may utilize a plurality of lower strength and less stiff cords in the lateral ends of both pieces of ply in the overlapped B region. These cords may be roughly half as strong and half as stiff as the remainder of the ply cords. Once layered, these cords would have strength and stiffness comparable to the remainder of the ply sheet.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a schematic top view of a ply fabric undergoing shearing;

FIG. 2 is a schematic of the cut ply material being spliced together;

FIG. 3 is a cross-sectional view of two ends of a layer of ply which are joined together in a conventional lap splice;

FIG. 4 is a cross-sectional view of two ends of a ply of first embodiment of the present invention which are joined together;

FIG. 5 is a cross-sectional view of two ends of a ply of second embodiment of the present invention which are joined together; and

FIG. 6 is a cross-sectional view of two ends of a ply of third embodiment of the present invention which are joined together.

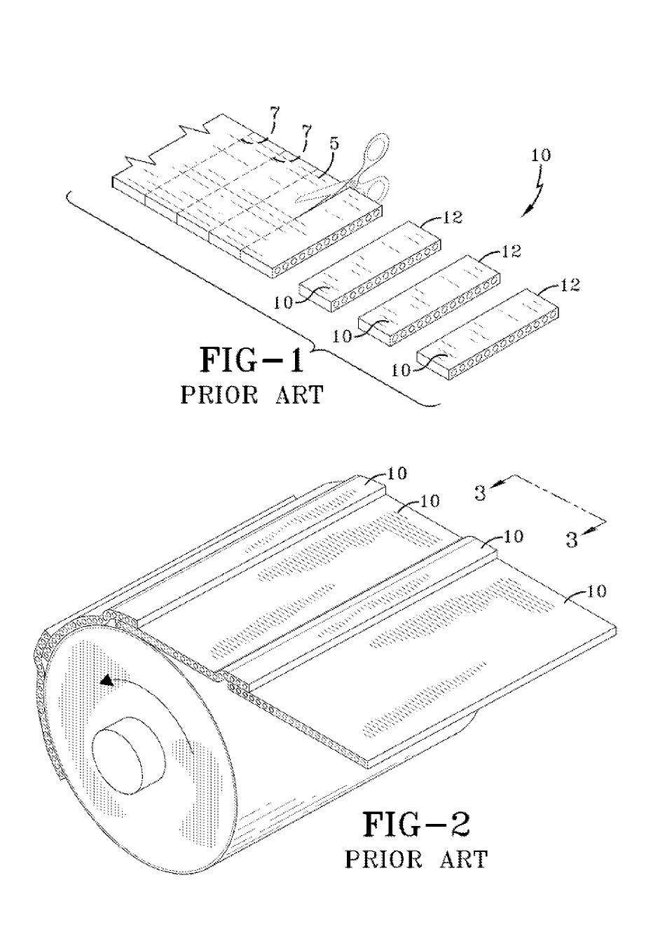

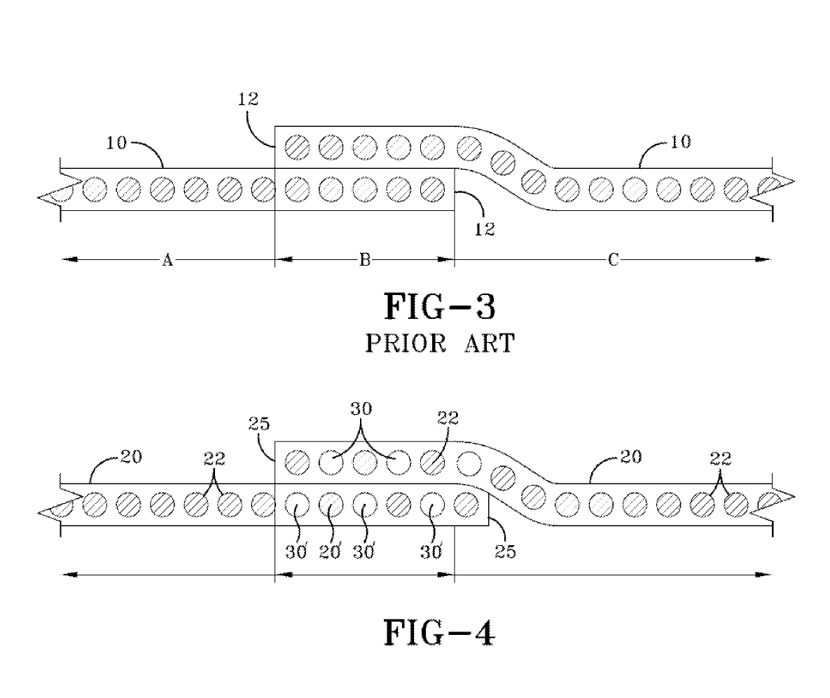

### DETAILED DESCRIPTION OF THE INVENTION

A first embodiment of the present invention is shown in FIG. 4, which illustrates a lap joint useful for joining two cut lengths of ply fabric 20 together. The ply fabric 20 has a plurality of parallel spaced cords 22 arranged transverse to the length of the sheet of the material. Each end 25 of the ply fabric has two or more dummy cords 30. Preferably, the dummy cords 30 are alternated with ply cords 20. The dummy spacer cords are only located at the lateral ends of ply fabric 20. The ply cords 22 may be comprised of nylon, polyester, steel or other materials known to those skilled in the art. The ply cords 22 are arranged to be parallel to each other. The dummy spacer cord 30 may be made of a hollow cord or low density cord. The dummy spacer cord 30 has a lower strength than the ply cord 20, and preferably has a modulus of elasticity 75% or less than the ply cords 20. More preferably, the dummy spacer cord 30 has a modulus of elasticity of 50% or less than the ply cords 20. When the ply ends are joined together in a lap joint as shown in FIG. 4, the dummy spacer cord on one end 25 is located across from and adjacent to a functional reinforcement cord 20 on a second end 25′. The resulting lap joint has the strength of the lap joint but without the disadvantage of the overlap of two functional cords.

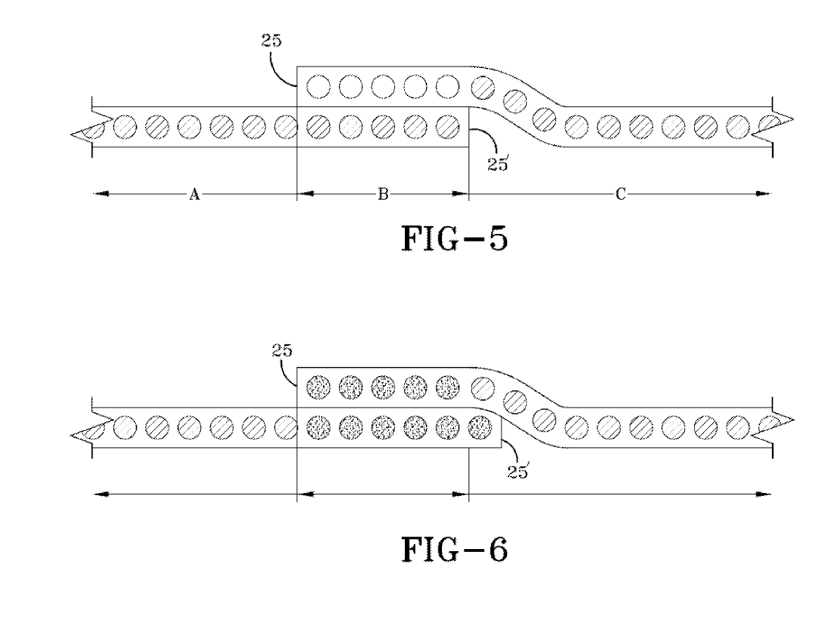

FIG. 5 illustrates a second embodiment of the invention. One end 25 of the ply fabric has a plurality of dummy cords, while the other end 25′ to be joined has a plurality of regular cords. When the ends 25, 25′ are lap spliced together, the dummy cords are located across from and adjacent to the regular cords.

FIG. 6 illustrates a third embodiment of the invention. Each end 25 of the ply fabric has a plurality of cords which have a reduced strength, on the order of 50% or less. When the ends 25, 25′ are lap spliced together, the reduced strength cords are located adjacent the reduced strength cords.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of forming a layer of tire ply comprising the following steps:
a. providing a first sheet of ply having a first lateral end, and having a plurality of functional reinforcement cords and two or more dummy spacer cords at said first lateral end;
b. providing a second sheet of ply having a second lateral end to be joined together with the first lateral end of said first sheet of ply;
c. said second sheet of ply having a plurality of functional reinforcement cords and two or more dummy spacer cords at said second lateral end;
d. overlapping the first and second lateral ends so that the dummy cord of one of said ends is located adjacent a functional cord of the second of said ends.

2. A method of forming a layer of tire ply comprising the following steps:
a. providing a first sheet of ply having a first lateral end, and having a plurality of functional reinforcement cords and a plurality of dummy spacer cords at said first lateral end;
b. providing a second sheet of ply having a second lateral end to be joined together with the first lateral end of said first sheet of ply;
c. said second sheet of ply having a plurality of functional reinforcement cords at said second lateral end;
d. overlapping the first and second lateral ends so that the dummy cord of one of said ends is located adjacent a functional cord of the second of said ends.

3. The method of claim 2 wherein the second lateral end has no dummy spacer cords.

4. A method of forming a layer of tire ply comprising the following steps:
a. providing a first sheet of ply having a first lateral end, and having a plurality of functional reinforcement cords and a plurality of reduced strength cords at said first lateral end, wherein the reduced strength cords have a lower modulus of elasticity than the functional reinforcement cords;
b. providing a second sheet of ply having a second lateral end to be joined together with the first lateral end of said first sheet of ply;
c. said second sheet of ply having a plurality of functional reinforcement cords at said second lateral end and a plurality of reduced strength cords at said second lateral end, wherein the reduced strength cords have a lower modulus of elasticity than the functional reinforcement cords;
d. overlapping the first and second lateral ends so that the reduced strength cords of the first lateral end overlaps with the reduced strength cords of the second lateral end.
